(19) United States
(12) Patent Application Publication
(10) Pub. No.: US 2009/0169333 A1
(43) Pub. Date: Jul. 2, 2009

(54) Screw head

(75) Inventor: Mearl Wilson Stewart, Fancy Gap, VA (US)

Correspondence Address: Mearl W. Stewart, 485 Stonewall Road., Fancy Gap, VA, 24328, US

(73) Assignee: KAREN A. STEWART

(21) Appl. No.: 12/319,769

(22) Filed: Jan. 12, 2009

Related U.S. Application Data
(63) Continuation-in-part of application No. 11/680,141, filed on Feb. 28, 2007.
Application No. 11/680,141 is a continuation of application No. 11/102,916, filed on Apr. 8, 2005, now abandoned.

(51) Int. Cl. F16B 23/00

(52) U.S. Cl. 411/403

(57) ABSTRACT

This new screw head consists of a recess resembling a double dove tail design. It is capable of receiving a conventional twist bit. Its primary purposes are to increase safety and expediency.

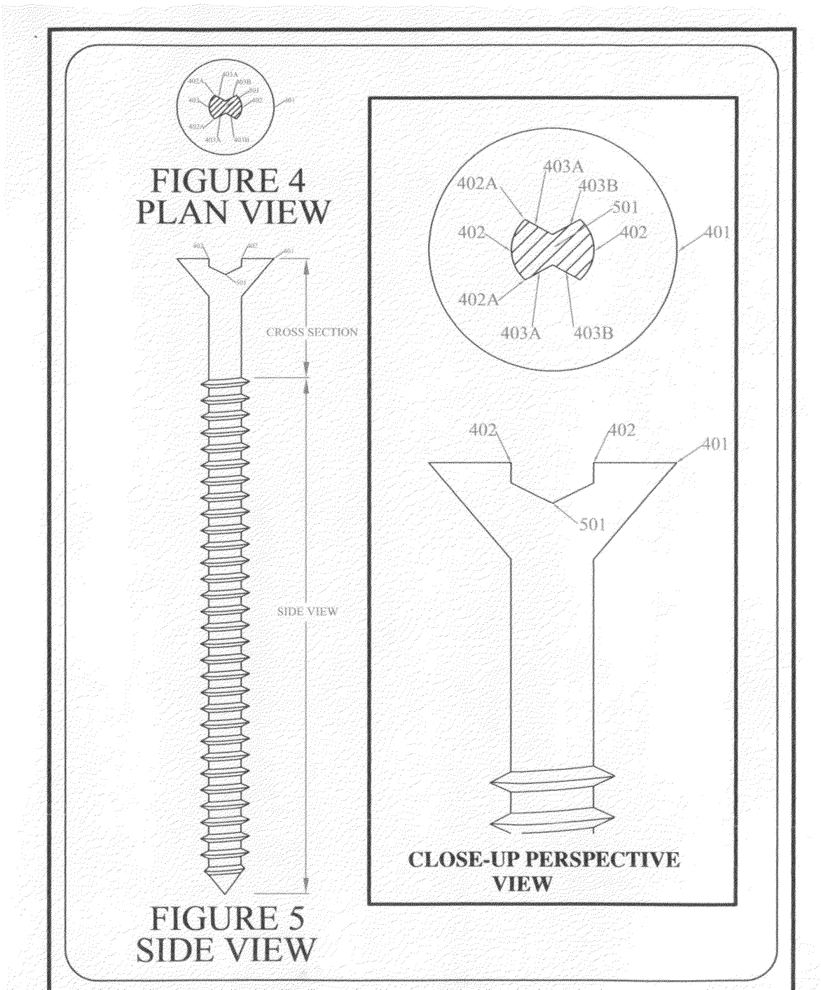

### CROSS-REFERENCE TO RELATED APPLICATION

This application is a Continuation-In-Part of U.S. application Ser. No. 11/680,141, filed Feb. 28, 2007, which is, in turn, a Continuation of U.S. application Ser. No. 11/102,916, filed Apr. 8, 2005.

### BACKGROUND

The idea was conceived by the inventor shortly after completing a build-out of a new factory location in 1984. While 40 feet off the ground on scaffolding, the inventor experienced the challenges of installing electrical and conduit lines with conventional screws.

In 1991, a patent attorney was hired to search prior art. None was found.

### FIELD OF INVENTION

The present invention is a screw head configured to resemble a double dove tail. The recess is capable of receiving a conventional drill bit.

### DESCRIPTION

The double dovetail screw head design can be utilized for use in wood, plastic and all types of metal. Said screw can be manufactured in a number of sizes in length and diameter to fit a specific need. An example is the utilization of a very small brass screw ¼ inch long to attach a hinge in a small jewelry box to a much larger screw needed to attach a leg to a sofa.

The double dovetail screw is manufactured on a cold header machine with the thread produced on a roll threaded machine. Said screw can be constructed out of steel, aluminum, brass or plastic. The exterior finish on the screw can be of zink, black oxide, black phosphate, ceramic coated, anodized, color powdered coated or left uncoated.

There are a number of head configurations to fit a specific requirement, such as a flat head, round head, pan head, binding head and oval head. The threads also vary to fit a particular need. A fine thread is used to attach drywall to metal studs; courser threads are used to attach drywall to wood studs; self-drilling points are used for sheet metal applications and self-threading threads are used for metal applications.

I have tested the double dovetail screw in a pneumatic nail gun for use in attaching exterior decking to the under joists. The results were a rapid construction with improved visual esthetics. An important feature (having a wood deck myself that requires periodic replacement of some boards) is that, unlike a conventional nail normally used in deck construction, the screw can be removed, if required.

### SUMMARY

With it's 90 degree walls, the screw head has increased purchase power over other designs, including the Phillip's screw head. The design is encapsulated and therefore does not allow lateral slippage that is inherent in the slotted screw head. This results in fewer injuries and much less frustration.

The overall area of the screw head's wall surfaces is greater than the overall area of the typical square drive screw. That feature, along with the curved sections of the said screw head, adds increased stability and reduces cam out.

The design lends itself to accepting a decorative cap for aesthetic purposed.

1. A screw comprising:
(A) a recess in the screw head resembling a double dove tail design.
(B) a recess, predetermined in size, that is inclusive of the side walls extending from a top surface to a bottom surface with corresponding upper and lower segments where the side wall meets the respective top and bottom walls and including a first arcuate wall having a constant radial distance from the central axis and a second generally planer wall segment which are joined at a common edge.
